(19) United States
(12) Patent Application Publication
(10) Pub. No.: US 2012/0288623 A1
(43) Pub. Date: Nov. 15, 2012

(54) METHOD FOR PLASTIC RESTORATION AND KIT THEREFOR

(76) Inventor: Lewyn Boler, Stockton, CA (US)

(21) Appl. No.: 13/240,503

(22) Filed: Sep. 22, 2011

Related U.S. Application Data
(60) Provisional application No. 61/484,131, filed on May 9, 2011.

(51) Int. Cl. B05D 5/00; B05D 3/12; B24D 11/00; B05C 1/00

(52) U.S. Cl. 427/140; 118/264; 451/526

(57) ABSTRACT

A method of plastic restoration is disclosed. A plastic surface is scoured with an abrasive dust mixture and a scouring pad. The plastic surface is wiped to remove a residue of the abrasive dust mixture. A sealer is applied to the plastic surface. A kit for use in plastic restoration is also disclosed. The kit has an abrasive dust mixture. The abrasive dust mixture includes an abrasive, one or more aliphatic hydrocarbons, an emulsifier, and water. The kit also has a scouring pad for scouring a plastic surface with the abrasive dust mixture.

### RELATED APPLICATIONS

This application claims priority to U.S. provisional patent application 61/484,131 filed on May 9^{th}, 2011 and entitled “PLASTIC HEADLIGHT RESTORATION METHOD.” This application hereby incorporates the 61/484,131 provisional application by reference in its entirety.

### FIELD

The claimed invention generally relates to methods of plastic restoration, and more particularly to methods and kits which can be used to restore the clarity of plastic surfaces such as, but not limited to, headlight surfaces.

### BACKGROUND

It is more and more common to find automobiles that have headlights with outer plastic surfaces. Plastic headlights offer manufacturers cost savings and more design flexibility when compared to glass headlights. Plastic headlights also have a higher resistance to cracking, but unfortunately, they are susceptible to dulling over time. For example, plastic headlights may become dull or yellow due to exposure to ultraviolet (UV) rays and/or oxidation. Manufacturers often coat plastic headlights with a sealer to prevent or slow such damage, but over time and with exposure to elements, for example weather, salt, road debris, etc, the protective sealant coating can become damaged or can wear away.

Even if the sealant does not wear away completely, eventually enough exposure to UV light will reach the plastic headlight to dull the headlight or otherwise allow it to become oxidized and dull. As plastic headlights become dull, they not only look unattractive, they lose clarity and transmit light less effectively, thereby reducing a driver's visible field while driving after dark.

It has been reported that more than 40% of all fatal car accidents occur at night, despite 60% less traffic on the roads at that time. Clearly, reduced visibility is a major concern for drivers. In a recent study, the Automotive Aftermarket Industry Association (AAIA) Car Care Council found that limited visibility was a factor in 2.8 million accidents, and a chief culprit of dim headlights is the plastic headlight lens. Accordingly, automobile owners have been encouraged to inspect their headlights for signs of dullness and remedy the situation as necessary to improve night-time visibility. Unfortunately, car owners have had either expensive or ineffective choices for improving their headlight clarity.

One option to restore headlight clarity is headlight lens replacement with a new, used, or refurbished lens assembly. This can cost be very costly, however, as many headlight lenses are only available as part of an entire headlight assembly which can cost several hundred dollars each. Another option is to have the headlight lens professionally restored for a typical cost of $25-$100 per headlight, or more. In addition to facing high costs for professional headlight lens restoration, customers also run the risk of being ripped off by people pretending to be professionals at venues such as flea markets and swap meets. Effective professional restoration, however, often involves specialized power tools for mechanically abrading and polishing the headlight lenses. Such professional tools are often impractical or too expensive for the average car owner to purchase. Some companies, however, sell do-it-yourself headlight restoration kits which feature abrasives for use with home power tools such as drills and power drivers. For example, as illustrated in FIG. 1A, a headlight 20 has been masked off by masking tape 22 so that it can be abraded by a power attachment 24 driven by a power tool 26. Different products of this type may require a variety of power attachments 24, for example pads with progressively finer sanding grits and/or they may be used with one or more polishing compounds. The sanding pads and/or polishing compounds used with these powered systems require the high velocity rotation of the power tool 26. While this can produce good results in the hands of an experienced operator, care must be taken to mask 22 around the headlight 20 carefully so that the high velocity attachment 24 does not scratch the car's body 28 around the headlight 20. Some people may be tempted to forego the masking tape, thinking they can control the powered tool 26, but there is a lot of torque to control with these types of solutions, and the powered scrubbing attachment 24 can easily spin off the headlight 20 and onto the car's body 28 as illustrated in FIG. 1B. The motion of the power tool may be so hard to control for some people that even masking can be ineffective. Moreover, the force and speed of the power tool can easily impart new scratches or other damage to the lens surface, thereby harming rather than improving headlight clarity. The drawbacks of these powered solutions are a particularly acute problem for do-it-yourself operators to whom such solutions are primarily marketed. Furthermore, the professional restoration techniques described above, as well as the do-it-yourself solutions which emulate the professional restoration techniques, can take several hours to complete due to cleaning, sanding, taping, etc.

As a final option, some companies (who highlight the difficulties and expenses of the above-mentioned options) are selling headlight restoration products which are wiped on and removed with a soft applicator, similar to how a wax would be applied and removed from a car. Such solutions claim to remove oxidation and restore headlights in less than a minute, and while easy to do and relatively inexpensive, are not as effective as the abrasive techniques when done professionally nor are the results as long lasting.

Therefore, there is a need for a simple headlight restoration method and kit that effectively enable abrasive headlight restoration for professional long-lasting results without the need for power tools, masking, labor-intensive and time consuming steps, specialized skills, or expensive supplies. Such a plastic restoration method and kit would be useful for restoring the clarity of automotive, boating, aircraft, and other transportation headlights, as well as other plastic surfaces.

### SUMMARY

A method of plastic restoration is disclosed. A plastic surface is scoured with an abrasive dust mixture and a scouring pad. The plastic surface is wiped to remove a residue of the abrasive dust mixture. A sealer is applied to the plastic surface.

Another method of plastic restoration is disclosed. A headlight surface is scoured with an abrasive dust mixture and a plastic scouring pad, without using power tools, wherein the abrasive dust mixture comprises about 50% of a diamond dust powder, about 25% of a kerosene, about 2.5% pine oil, about 5% soap, and approximately 17.5% water, respectively, by weight. The headlight surface is wiped with a dry towel to remove a residue of the abrasive dust mixture. A sealer is applied to the headlight surface with a cotton ball in one or more uni-directional strokes.

A kit for use in plastic restoration is also disclosed. The kit has an abrasive dust mixture. The abrasive dust mixture includes an abrasive, one or more aliphatic hydrocarbons, an emulsifier, and water. The kit also has a scouring pad for scouring a plastic surface with the abrasive dust mixture.

### BRIEF DESCRIPTION OF THE DRAWINGS

FIGS. 1A and 1B schematically illustrate prior art examples of headlight restoration which require the use of power tools.

FIGS. 2A-2C schematically illustrate one embodiment of a method for plastic restoration.

FIGS. 3A-3B schematically illustrate embodiments of a kit for plastic restoration.

FIG. 4 schematically illustrates another embodiment of a method for plastic restoration.

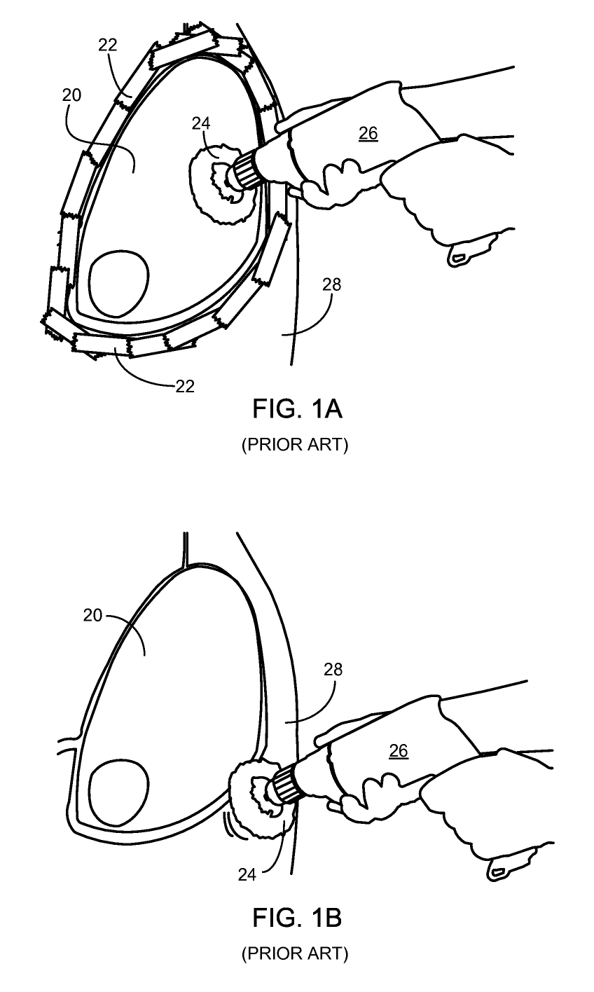

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION

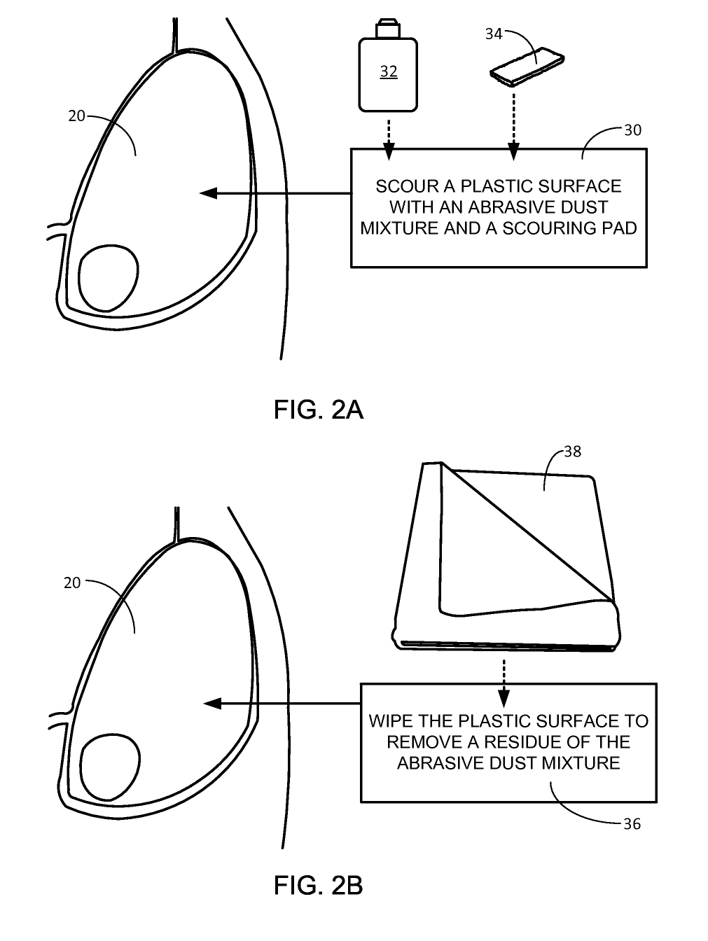

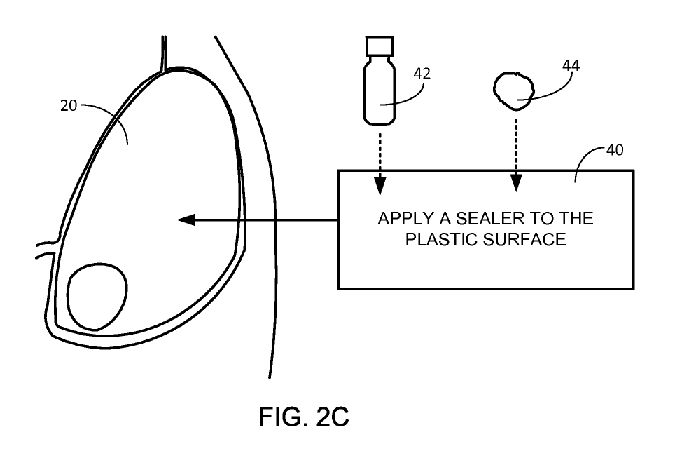

FIGS. 2A-2C schematically illustrate one embodiment of a method for plastic restoration. For convenience, the embodiments disclosed herein are described with reference to headlight restoration, however it should be understood that headlight restoration is just one application for the disclosed plastic restoration methods and kits. The headlights may be made from one or more of a variety of plastics, including, but not limited to polycarbonate. Furthermore, the term “headlight” as used herein refers to the transparent or light transmissive plastic outer cover of a headlight assembly (whether or not it is attached to a headlight assembly), such as headlight 20 illustrated in FIG. 2A. Although discussed in terms of a headlight, the claimed plastic restoration method is also applicable to other plastic items, including, but not limited to plastic tail lights, plastic windows, plastic emergency flashers, plastic lenses, and even items which have been coated by a plastic coating. Furthermore, although the embodiments herein are discussed with respect to automotive applications, it should be apparent that the disclosed methods, kits, and their equivalents are useful in a variety of non-automotive applications as well, including, but not limited to marine applications, avionic applications, and home improvement applications.

Returning to the method embodied by FIGS. 2A-2C, in a first action 30, a plastic surface (such as headlight 20) is scoured with an abrasive dust mixture 32 and a scouring pad 34. The abrasive dust mixture 32 may include one or more abrasive powders, one or more aliphatic hydrocarbons, an emulsifier, and water.

Suitable abrasives include, but are not limited to silicon dioxide, diatomaceous earth, diamond dust powder, polycrystalline diamond (synthetic diamond) dust powder, alumina, calcium carbonate, ceramics, and carborundum, fused aluminum oxide, ceramic aluminum oxide, heat treated aluminum oxide, fused aluminum oxide, cubic boron nitride, silica, silicon carbide, pumice, calcium carbonate, perlite, mica, rigid polymeric material, talc, boron carbide, titanium carbide, alumina zirconia, diamond, ceria, boron oxides in the form of B_{6O} and B₁₀₀, tripoli, boron carbonitride, sintered alpha alumina-based abrasive particles, sintered alumina, and combinations thereof. Those skilled in the art will recognize alternate abrasives which may be used in other embodiments, and such alternatives and modifications are intended to be covered by the scope of the appended claims. Depending on the embodiment, the abrasive may account for 20%-80% of the total abrasive dust mixture 32, by weight. Optimally, but not necessarily, the abrasive in some embodiments is about 40-60% of the total abrasive dust mixture 32, by weight. Furthermore, in the preferred embodiments, the abrasive powders may be primarily about 50 microns or less in size. In other embodiments, the abrasive powders may have an average size of between about 0.5 microns and about 1500 microns, although other embodiments may use larger or smaller sized abrasive particles to achieve additional abrasive effect. In some embodiments, the abrasive particles may absorb unwanted surfactants from the lens being restored. Without being limited to a particular theory, it is believed that when the abrasive dust mixture 32 is applied to the headlight lens in a liquid form as described herein, oxidation detaches from the lens and joins the abrasive dust mixture, helping the abrasive dust mixture 32 to dry faster. As the liquid components of the abrasive dust mixture 32 evaporate, embodiments with absorbent abrasive particles are able to utilize the dried and/or drying absorbent abrasive particles in the scavenging of oil, grease, and other elements which may be present on the headlight that could interfere with the headlight restoration process.

Suitable aliphatic hydrocarbons include, but are not limited to kerosene and other types of petroleum distillates which will not damage the plastic surface 20. Those skilled in the art can easily determine if an aliphatic hydrocarbon will damage the plastic surface 20 and can select one or more suitable aliphatic hydrocarbons. Depending on the embodiment, the one or more aliphatic hydrocarbons may account for approximately 25% of the total abrasive dust mixture 32, by weight, though a range of between approximately 10-60% may be appropriate in other embodiments, depending on the amount of abrasion desired and the amount of pressure to be applied to the lens.

The emulsifier may include, but is not limited to pine oil, soap, sodium laureth sulphate, sodium lauryl ether sulphate, and combinations thereof. Depending on the embodiment, the emulsifier may account for approximately 7.5% of the total abrasive dust mixture 32, by weight, though a range of between approximately 4% to 30% by weight may be used in other embodiments. In still other embodiments, the emulsifier (surfactant) may account for a greater or lesser percent, as those skilled in the art would appreciate. In one embodiment, the emulsifier comprises pine oil and soap, with the pine oil accounting for approximately 2.5% and the soap accounting for approximately 5% of the abrasive dust mixture by weight, respectively.

Depending on the embodiment, the water may account for approximately 17.5% of the total abrasive dust mixture 32, by weight, though a range of about 5% to about 30% of water may be used in other embodiments. Those skilled in the art may recognize that other solvents besides water may be used in the abrasive dust mixture, provided the solvents do not damage the plastic surface being restored.

In a preferred embodiment, the abrasive dust mixture 32 comprises approximately 50% abrasive, approximately 25% of one or more aliphatic hydrocarbons, approximately 7.5% emulsifier, and approximately 17.5% water, respectively, by weight. In another, non-limiting embodiment of this preferred embodiment, the abrasive dust mixture 32 comprises approximately 50% abrasive, approximately 25% kerosene, approximately 2.5% pine oil, approximately 5% soap, and approximately 17.5% water, respectively, by weight. It has been discovered that the compositions of these embodiments provide a desirably creamy consistency to the abrasive dust mixture, thereby making it easier to apply. Other embodiments, however, may have other percentages of composition by weight as noted above.

As mentioned above with respect to FIGS. 2A-2C, the plastic surface (such as headlight 20) is scoured with the abrasive dust mixture 32 and a scouring pad 34. Suitable examples of a scouring pad 34 include, but are not limited to, a plastic scrubber, a plastic scouring pad, a synthetic scrubber, and a synthetic scouring pad. For example, scouring pads such as the 3M™ Scotch-Brite™ Purple Scour Pads (3M ID Number 70-0713-1175-0), the 3M™ Scotch-Brite™ Heavy Duty Scour Pads (3M ID Number 61-5000-2592-1), or the 3M® Scotch-Bright™ General Purpose Scouring Pads (3M ID Number 61-5000-6024-1) work very well with this method. In some embodiments, it is preferred that the scouring pad 34 defines pores where the abrasive can be embedded in response to pressure, thereby reducing or minimizing scratching of the headlight 20 during scouring.

It has surprisingly been discovered that the combination of the scouring pad 34 and the abrasive dust mixture 32 enable oxidation to be abrasively removed from headlights without the need for power tools. Prior art abrasive mixtures are ineffective without power tools. Similarly, plastic scour pads alone will not deoxidize headlights. However, without being limited to a particular theory, the disclosed combination of the scour pad 34 and the abrasive dust mixture 32 enables a person to hand-scour a headlight with a force greater than the oxidation adhesion to remove headlight oxidation without marring and without the need for power tools.

In a second action 36, as schematically illustrated in FIG. 2B, the plastic surface 20 is wiped to remove a residue of the abrasive dust mixture 32. This wiping may be done, for example, with a dry towel 38. Suitable examples of a towel 38 include, but are not limited to reduced-lint or “lint-free” towels, micro-fiber towels, and cotton towels. At this point, the headlight surface 20 has been cleaned to remove surface damage, such as oxidation. In a third action 40, as schematically illustrated in FIG. 2C, a sealer 42 is applied to the plastic surface 20. The sealer coating clears up any dullness and completes the restoration of the headlight clarity for professional results. Examples of the sealer 42 include, but are not limited to a polyurethane sealer and a spar varnish. It should be understood that the term “sealer” encompasses sealers and resealers, regardless of whether or not the original plastic surface was sealed, partially sealed, or unsealed. In a preferred embodiment, the sealer 42 is applied to the headlight 20 with a cotton ball 44. It has been discovered that a cotton ball 44 provides a high level of clarity, smoothness, and streak-free appearance on the headlight 20 when used with a polyurethane sealer or a spar varnish. Other embodiments may use a different sealer, however, it is preferred that the water and/or solvent content of the sealer be chosen or formulated to allow the sealer to flow and level on the lens as it is applied to the headlight, rather than having the sealer dry too quickly before leveling out. Those skilled in the art may easily select or formulate a sealer with such desired properties. Furthermore, when using a cotton ball 44 to apply the sealer, it is preferred to apply the sealer to the plastic surface 20 in one or more uni-directional strokes. The sealer can then be allowed to dry.

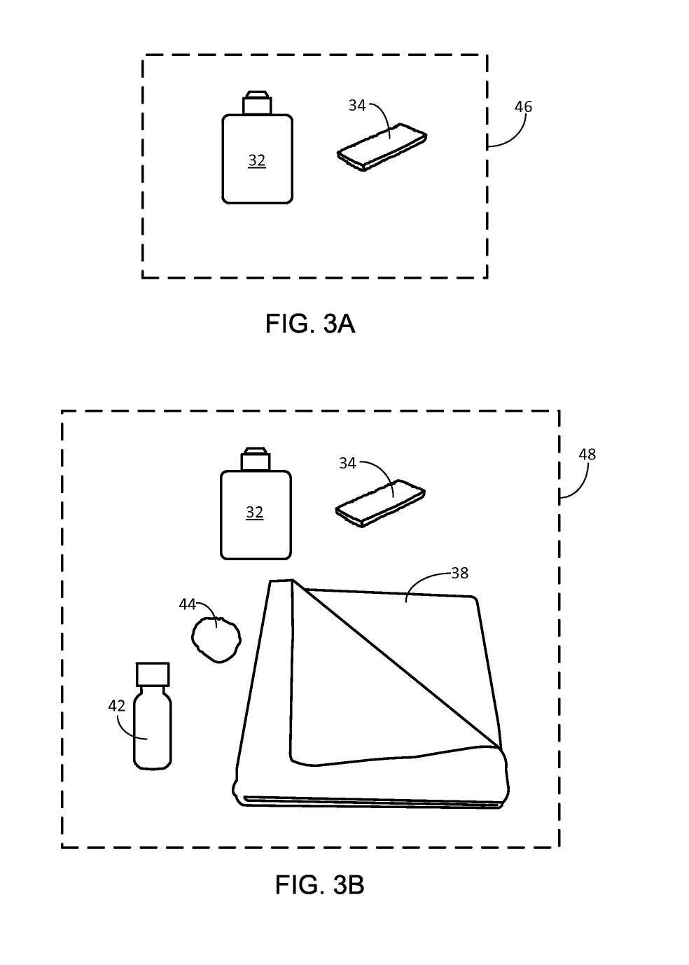

The methods for plastic restoration discussed above, and their equivalents, can be completed for a headlight in under thirty minutes, and preferably in under approximately ten minutes, providing a substantial time savings over existing professional methods. Furthermore, these methods and their equivalents also enable people to restore the clarity of plastic surfaces such as headlights without the need for power tools, masking, or specialized training. Therefore, it would also be useful and desirable to provide kits having one or more of the necessary items used in the disclosed plastic restoration methods so that people can easily purchase one or more of the items they would need to implement the method for headlight restoration. FIG. 3A illustrates one embodiment of a kit 46 for use in plastic restoration. In this embodiment, the kit 46 includes an abrasive dust mixture 32 and a scouring pad 34, the features of which have been discussed above. FIG. 3B illustrates another embodiment of a kit 48 for use in plastic restoration. In this embodiment, the kit 48 includes an abrasive dust mixture 32, a scouring pad 34, a towel 38, a sealer 42, and a cotton ball 44, the features of which have been discussed above. Other kits for plastic restoration could also be produced to include one or more of the items in the kit 48.

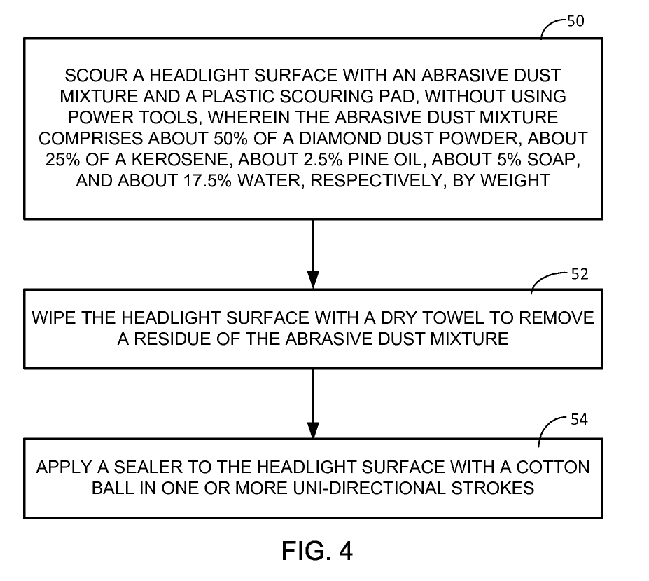

FIG. 4 illustrates another embodiment of a method for plastic restoration. In a first action 50, a headlight surface is scoured with an abrasive dust mixture and a plastic scouring pad, without using power tools. The abrasive dust mixture comprises about 50% of a diamond dust powder, approximately 25% of a kerosene, about 2.5% pine oil, about 5% soap, and about 17.5% water, respectively, by weight. In a second action 52, the headlight surface is wiped with a dry towel to remove a residue of the abrasive dust mixture. In a third action 54, a sealer is applied to the headlight surface with a cotton ball in one or more uni-directional strokes. Examples of the sealer include, but are not limited to a polyurethane sealer and a spar varnish.

Having thus described several embodiments of the claimed invention, it will be rather apparent to those skilled in the art that the foregoing detailed disclosure is intended to be presented by way of example only, and is not limiting. Many advantages for the methods of plastic restoration and their associated kits have been discussed, including the ability to restore the clarity of dulled plastic surfaces, for example headlights, without the need for power tools or masking, while still obtaining professional quality results. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

What is claimed is:

1. A method of plastic restoration, comprising:
scouring a plastic surface with an abrasive dust mixture and a scouring pad;
wiping the plastic surface to remove a residue of the abrasive dust mixture; and
applying a sealer to the plastic surface.

2. The method of claim 1, wherein the scouring pad is selected from the group consisting of a plastic scrubber, a plastic scouring pad, a synthetic scrubber, and a synthetic scouring pad.

3. The method of claim 1, wherein the abrasive dust mixture comprises:
an abrasive;
one or more aliphatic hydrocarbons;
an emulsifier; and
water.

4. The method of claim 3, wherein the abrasive dust mixture comprises:
a range of about 20% to about 80% abrasive by weight;
a range of about 10% to about 60% of the one or more aliphatic hydrocarbons by weight;
a range of about 4% to about 30% of the emulsifier by weight; and
a range of about 5% to about 30% of water by weight.

5. The method of claim 3, wherein the abrasive comprises a substance selected from the group consisting of silicon dioxide, diatomaceous earth, diamond dust powder, polycrystalline diamond dust powder, alumina, calcium carbonate, ceramics, carborundum, fused aluminum oxide, ceramic aluminum oxide, heat treated aluminum oxide, fused aluminum oxide, cubic boron nitride, silica, silicon carbide, pumice, calcium carbonate, perlite, mica, rigid polymeric material, talc, boron carbide, titanium carbide, alumina zirconia, diamond, ceria, boron oxides in the form of B_{6O} and B₁₀₀, tripoli, boron carbonitride, sintered alpha alumina-based abrasive particles, and sintered alumina.

6. The method of claim 1, wherein the plastic surface comprises a headlight surface.

7. The method of claim 1, wherein scouring the plastic surface with the abrasive dust mixture and the scouring pad comprises hand scouring without power tools.

8. The method of claim 1, wherein wiping the plastic surface to remove the residue of the abrasive dust mixture comprises wiping the plastic surface with a dry towel.

9. The method of claim 1, wherein applying the sealer to the plastic surface comprises applying the sealer to the plastic surface with a cotton ball.

10. The method of claim 9, wherein applying the sealer to the plastic surface with the cotton ball comprises applying the sealer to the plastic surface with the cotton ball in one or more uni-directional strokes.

11. The method of claim 1, wherein the sealer is selected from the group consisting of a polyurethane sealer and a spar varnish.

12. A method of plastic restoration, comprising:
scouring a headlight surface with an abrasive dust mixture and a plastic scouring pad, without using power tools, wherein the abrasive dust mixture comprises about 50% of a diamond dust powder, about 25% of a kerosene, about 2.5% pine oil, about 5% soap, and approximately 17.5% water, respectively, by weight;
wiping the headlight surface with a dry towel to remove a residue of the abrasive dust mixture; and
applying a sealer to the headlight surface with a cotton ball in one or more uni-directional strokes.

13. The method of claim 12, wherein the abrasive comprises a substance selected from the group consisting of silicon dioxide, diatomaceous earth, diamond dust powder, polycrystalline diamond dust powder, alumina, calcium carbonate, ceramics, carborundum, fused aluminum oxide, ceramic aluminum oxide, heat treated aluminum oxide, fused aluminum oxide, cubic boron nitride, silica, silicon carbide, pumice, calcium carbonate, perlite, mica, rigid polymeric material, talc, boron carbide, titanium carbide, alumina zirconia, diamond, ceria, boron oxides in the form of B_{6O} and B₁₀₀, tripoli, boron carbonitride, sintered alpha alumina-based abrasive particles, and sintered alumina.

14. The method of claim 12, wherein the sealant is selected from the group consisting of polyurethane and a spar varnish.

15. A kit for use in plastic restoration, comprising:
a) an abrasive dust mixture comprising:
1) an abrasive;
2) one or more aliphatic hydrocarbons;
3) an emulsifier; and
4) water; and
b) a scouring pad for scouring a plastic surface with the abrasive dust mixture.

16. The kit of claim 15, further comprising:
c) a sealer for application to the plastic surface after a residue of the abrasive dust mixture is removed from the plastic surface.

17. The kit of claim 16, further comprising:
d) a cotton ball for applying the sealer to the plastic surface.

18. The kit of claim 15, wherein the scouring pad is selected from the group consisting of a plastic scrubber, a plastic scouring pad, a synthetic scrubber, and a synthetic scouring pad.

19. The kit of claim 15, wherein the abrasive dust mixture comprises approximately 50% abrasive, approximately 25% of the one or more aliphatic hydrocarbons, approximately 7.5% emulsifier, and approximately 17.5% water, respectively, by weight.

20. The kit of claim 15, wherein the abrasive comprises a substance selected from the group consisting of silicon dioxide, diatomaceous earth, diamond dust powder, polycrystalline diamond dust powder, alumina, calcium carbonate, ceramics, carborundum, fused aluminum oxide, ceramic aluminum oxide, heat treated aluminum oxide, fused aluminum oxide, cubic boron nitride, silica, silicon carbide, pumice, calcium carbonate, perlite, mica, rigid polymeric material, talc, boron carbide, titanium carbide, alumina zirconia, diamond, ceria, boron oxides in the form of B_{6O} and B₁₀₀, tripoli, boron carbonitride, sintered alpha alumina-based abrasive particles, and sintered alumina.
